(19) United States
(12) Patent Application Publication
(10) Pub. No.: US 2012/0064138 A1
(43) Pub. Date: Mar. 15, 2012

(54) BIOCIDAL COMPOSITION

(75) Inventors: David Beveridge, Cheshire (GB); Stephen Critchley, Cheshire (GB); Karen Nicola Harvey, Cheshire (GB); Jeffrey Ronald King, Cheshire (GB); Kenneth Miller McCombe, Cheshire (GB); Martyn Howard Pendlebury, Cheshire (GB)

(73) Assignee: HARMAN TECHNOLOGY LIMITED, Knutsford (GB)

(21) Appl. No.: 13/265,511

(22) PCT Filed: Apr. 28, 2009
(86) PCT No.: PCT/GB2009/001067

§ 371 Date: Oct. 20, 2011

(51) Int. Cl. A01N 25/12; A01N 59/20; A01P 1/00; A01N 59/16

(52) U.S. Cl. 424/405; 424/618; 424/630; 424/641; 424/632; 424/633; 424/634; 424/635; 424/637

(57) ABSTRACT

The present invention relates to a biocidal composition comprising an inorganic compound and a polymer where the inorganic compound has been prepared using a controlled precipitation technique. The biocidal compositions overcome the settling and agglomeration problems of conventional inorganic biocidal compositions and offer enhanced activity, consistency, and stable long term release of the active species. The invention also relates to a method of preparation of the compositions and to their use as a biocidal composition and in making or coating articles comprising it.

The present invention relates to a biocidal composition comprising an inorganic compound and a polymer where the inorganic compound has been prepared using a controlled precipitation technique. The invention also relates to a method of preparation of the compositions and to their use as a biocidal agent and in making or coating articles.

It has long been known that certain inorganic compounds, for example compounds of silver, copper, and zinc, exhibit biocidal activity and may be used to combat the formation and growth of microorganisms including bacteria, fungi, viruses, algae, yeasts, and moulds. Such materials have been in use for many years. For instance, an early medicinal use of silver was the application of very dilute aqueous silver nitrate solutions to prevent eye infection in newborn babies. Various other silver salts, compounds, colloids, and complexes have also been used to prevent and control infection and have been shown to provide biocidal behaviour even in minute quantities. Another example is the use of the basic copper salt known as Bordeaux mixture as a spray for controlling growth of mildew on plants.

Many biocidal inorganic compounds, for example silver chloride, are normally regarded as insoluble. Without wishing to be limited to any particular theory, the biocidal activity is believed to be due to the availability of low concentrations of the relevant inorganic ionic species such as Ag⁺ that are adequate for activity. This biocidal activity may be described as oligodynamic.

Silver halides, especially silver chloride, represent a particularly useful class of silver compound showing biocidal, especially antimicrobial, activity. It is known to provide the antimicrobial silver compound in combination with one or more carrier materials, for example silver chloride/titanium dioxide or silver chloride/silica, and it is also known to provide antimicrobial silver halide in combination with one or more organic polymeric carriers. For example, published Japanese Patent Application 2005-139292 discloses a core-shell particle wherein the shell comprises a largely water insoluble silver salt. However, this publication does not disclose controlled precipitation of the silver salt.

One problem that may arise with such formulations is that of settling out from the carrier of the relatively dense inorganic salt particles. Settling out of the particles from such formulations can cause unpredictable changes in the concentration of the active biocidal agent in the composition. This makes it difficult to produce a composition having a specific concentration of inorganic ions and, thus, a particular effectiveness. This is a particular problem if there are large oversize inorganic salt particles present as these represent a considerable proportion of the available active agent, yet tend to settle out much more quickly, making it more difficult to maintain consistency in the concentration. Consistency of biocidal activity is essential in the use of such compositions.

Another problem associated with inorganic particle suspensions is aggregation or agglomeration of the particles, producing particles of larger effective sizes which can increase settling. Additionally, the presence of oversize particles or the agglomeration of smaller particles in suspensions and coating solutions can affect the properties of the formulation and also produce particles on the surface of the final product that are large enough to be noticeable to the touch.

Thus there is still interest in improved inorganic biocidal compositions that overcome the settling and agglomeration problems of conventional inorganic biocidal compositions, and that offer enhanced activity, consistency, and stable long term release of the active species. Such improved inorganic biocidal compositions have now been prepared using a controlled precipitation technique.

Controlled precipitation of silver halide is well known in the photographic industry for the preparation of silver halide photographic emulsions and enables control of the size, size distribution, morphology, composition, etc. of the precipitated silver halide particles. The preparation of the silver halide emulsion is carried out by a double-decomposition reaction by allowing equimolar amounts of a suitable silver salt, for example silver nitrate, to react with a suitable halide salt, for example sodium chloride, in aqueous solution in the presence of gelatin or another stabilising colloid.

In general there are two recognised techniques in the photographic industry for controlling the precipitation of silver halide; the so-called single jet and double-jet emulsification methods. In the single jet method, aqueous silver nitrate solution is added to a stirred solution containing a small amount of gelatin and a suitable soluble halide salt or a mixture of halide salts; alternatively, the halide salt solution is added to the silver salt. The disadvantage of such a single-jet process is that the crystals produced invariably have a relatively wide size distribution. In the alternative double-jet method, aqueous solutions of silver nitrate and soluble halide salts are added simultaneously to a stirred solution of gelatin. It is known to control the precipitation by appropriate choice of the solution concentrations and jetting rates or by feedback from the silver or halide concentration in the precipitation vessel using a suitable ion selective electrode. Alternatively, control may be obtained by means of a suitable mathematical program. Such methods are known in the art.

The presence of gelatin as a protective colloid stabiliser is important during the precipitation reaction and for the photographic properties of the emulsion. However gelatin is undesirable in biocidal compositions comprising inorganic salts.

Therefore according to the invention there is provided a biocidal composition comprising:

i) an inorganic compound; and

ii) a polymer;

wherein the inorganic compound is prepared by a controlled precipitation technique.

Typically, the inorganic compound and the polymer are in particulate form. The polymer is typically a thermoplastic polymer.

The inorganic compound may typically be a compound of silver, copper, or zinc.

According to one embodiment of the invention, the inorganic compound is a silver compound. The silver compound may be selected from, but not limited to, silver chloride, silver bromide, silver iodide, silver sulphate, silver carbonate, or silver oxide. Typically, the silver salt is silver chloride. Further, the silver compound may comprise an admixture of any two or more of the above compounds, for example silver chlorobromide. Typically, the silver compound comprises at least about 50% chloride, and most typically, the silver compound is silver chloride.

According to a second embodiment of the invention, the inorganic compound is a copper compound, typically a cupric or copper(II)-comprising compound, that is to say a compound of divalent copper. The copper(II) compound may be selected from, but not limited to, basic copper chloride, basic copper sulphate, basic copper carbonate, copper oxide, or copper hydroxide. Alternatively, the copper compound may be a cuprous or copper(I) compound, typically cuprous oxide or copper thiocyanate. Basic copper chloride is more typical, by which is meant a compound comprising cupric, chloride, and hydroxide moieties, including copper chloride hydroxide, dicopper chloride trihydroxide, compositions of the formulae CuCl(OH), Cu₂Cl(OH)₃, Cu₂(OH)₃Cl, CuCl_{0.5}(OH)_{1.5}, Cu₄Cl₂(OH)₆.3H₂O, Cu₃Cl₄(OH)₂.H₂O, Cu₅Cl₃(OH)₇, etc., any hydrates thereof, mixtures of any two or more such compounds, and nonstoichiometric compositions. Dicopper chloride trihydroxide is a most typical compound.

According to a third embodiment of the invention, the inorganic compound may be a zinc compound. The zinc compound may be selected from, but not limited to, zinc oxide, zinc sulphide, basic zinc sulphate, basic zinc chloride, basic zinc oxide, zinc borate, zinc hydroxide, zinc benzoate, any hydrates thereof, and mixtures of any two or more of such compounds. Zinc oxide is typical.

The average particle size of the inorganic compound is not limited, but is typically less than about 1 μm, more typically less than about 500 nm, still more typically between about 10 nm and about 500 nm. It is found that particles in this size range adhere to the (thermoplastic) polymer carrier particles thus avoiding settling out. The shape of the inorganic compound particles is not restricted, but in one typical embodiment of the invention the particles comprise silver chloride in the form of cubes. The proportion of inorganic compound in the composition may be up to about 20% by dry weight of the polymer, typically from about 0.1% to about 10% by dry weight, more typically from about 0.5% to about 5% by dry weight.

The polymer of the carrier particles may be any suitable particulate polymer, such as a thermoplastic polymer, for example polyamide, polyolefins such as polyethylene or polypropylene, polymethyl methacrylate (PMMA), polytetrafluoroethylene (PTFE), polyurethane (TPU), polystyrene, polyvinyl chloride (PVC), polyvinylidine chloride (PVDC), polyvinylacetate, polyesters such as poly(ethylene terephthalate) (PET) or poly (butylene terephthalate) (PBT), polyvinyl acetal, polyvinyl butyral, polycarbonate, or may be a copolymer such as a styrene-butadiene, ethylene-vinyl acetate (EVA), ethylene-acrylic acid (EAA), or acrylonitrile-butadiene-styrene (ABS) copolymer. Further, the particles of the polymer may comprise an admixture of any two or more of these polymers.

A typical particulate thermoplastic polymer is polyamide, including polyamide 6, polyamide 11, polyamide 12, polyamide 4/6, polyamide 6/6, polyamide 6/10, and polyamide 6/12. Polyamide 6/12, that is to say an amide copolymer comprising 6-amino hexanoic acid and 12-amino dodecanoic acid, is especially suitable. Another typical polyamide is polyamide 6, that is to say an amide comprising 6-aminohexanoic acid. Another suitable particulate thermoplastic polymer is polyethylene, including especially low density polyethylene. Still further typical thermoplastic polymers include polypropylene and polyurethane.

The average particle size of the polymer particles may be up to about 100 typically between about 1 μm and about 60 μm, most typically between about 5 μm and about 20 μm.

In addition to the components already mentioned, the composition of the invention may also contain further auxiliary agents as are known in the art, such as but not limited to plasticisers, lubricants, surfactants, dispersants, antifoaming agents, light stabilisers, antioxidants, antifoggants, and the like.

According to another aspect of the invention, there is provided a method for preparation of a biocidal composition comprising a controlled precipitation of an inorganic compound in the presence of a polymer.

Typically, the above method comprises the steps of:
i) providing a source of a cation and a source of an anion; and
ii) mixing the cation source and the source of an anion with a polymer to prepare an inorganic compound;
   wherein the inorganic compound is prepared using a controlled precipitation technique.

By the term “controlled precipitation” in the present invention is meant a technique that enables control of the particle size, size distribution, and shape of the precipitated inorganic salt particles by control of the reaction conditions, such as relative concentrations, pH, temperature, and rate of addition of the reactants (jetting rates).

The source of the cation typically comprises one of a silver, copper or zinc compound.

Typically, the controlled precipitation is carried out by the double jetting method; that is to say that separate aqueous solutions of a compound having the appropriate cation, i.e. silver, copper or zinc, and a salt of an appropriate counterion are simultaneously pumped into a precipitation vessel in the presence of a polymer, and the reaction mixture is stirred during the precipitation reaction. Good mixing is necessary for control of the reaction. The jetting nozzles for the cation and counterion solutions may be arranged below the liquid surface in the precipitation vessel to allow the reagents to be added directly into the mixture rather than onto the surface.

By “an appropriate counterion” is meant the anion necessary to provide the desired inorganic compound. For example, when the inorganic compound is a silver compound, the silver compound is typically silver chloride and the appropriate counterion is chloride. Any water-soluble silver and chloride salts are suitable, but a typically used silver salt is silver nitrate and a typically used chloride salt is sodium chloride. An alternative chloride salt is ammonium chloride. Further, when the inorganic compound is a copper compound, the compound is typically basic copper chloride and the appropriate counterion is hydroxide ion, that is to say an alkali.

It is normal to start with an initial liquid charge in the precipitation vessel to permit the reaction to be stirred at the commencement of jetting. It may also be advantageous for the jetting nozzles for addition of the reagents to be below the surface of the initial charge.

The polymer typically comprises particles of a thermoplastic polymer that may be in the form of a dispersion or suspension in water. In one embodiment of the invention, the dispersion may be present as the initial liquid charge to the precipitation vessel before jetting the solutions containing the cation and anion.

Alternatively, the dispersion may be pre-mixed with either the solution containing the cation or the solution containing the anion and jetted with these solutions, or it may be added as a separate addition during the precipitation reaction or by a combination of such methods.

The dispersion may be prepared by dispersing the polymer particles in water using a suitable stirrer, optionally in the presence of one or more surfactants or dispersants to aid wetting of the particles and to stabilise the dispersion.

Typically, the polymer dispersion comprises a surfactant. The surfactant used is not particularly limited as long as it is compatible with the other components. Examples of suitable surfactants include but are not limited to nonionic surface active agents such as alkylene oxide derivatives, for example alkoxylated alcohol ethers, acetylenic alcohol polyethylene glycol ethers, polyethylene glycol alkylaryl ethers, polyethylene glycol esters, or polyethylene glycol/polypropylene glycol condensates; glycidol derivatives; aliphatic esters of polyhydric alcohols or sucrose; anionic surfactants such as alkyl naphthalene sulphonates, alkylbenzenesulphonates, alkyl sulphonates, dialkyl sulphosuccinates, N-acyl-N-alkyl taurines, N-acyl sarcosines, or surfactants comprising a sulphuric acid ester group, such as alkyl sulphuric acid esters and sulphated polyethylene glycol alkyl or alkylaryl ethers; and salts of the above anionic surfactants. Such surfactants are well known in the art. Alkoxylated alcohol and sulphated alkoxylated alcohol surfactants are especially suitable. The proportion of surfactant may be up to about 10% of the polymer by dry weight, typically in the range of about 1% to about 2.5%.

According to one embodiment of the invention, the inorganic compound is a silver compound. Typically, the silver compound is silver chloride. For the purpose of illustrating the invention, reference will be made to the embodiment where the silver compound is silver chloride for convenience. However, it will be appreciated that the details of the invention apply irrespective of the counterion to the silver.

When the inorganic compound is a silver compound, control of the precipitation may typically be achieved by control of the silver ion concentration or of the chloride ion concentration. The silver ions and chloride ions may be added to the precipitation in equimolar quantities, but more typically the precipitation is carried out in the presence of an excess of chloride ions, which can be a small excess.

To maintain the chloride excess, the minimum concentration of chloride ions during the precipitation reaction should be at least about 0.5×10⁻⁴ molar representing approximately a twofold excess of chloride ion. The term molar implies moles/litre.

Typically, the concentration of chloride ions is at least about 10⁻⁴ molar, with a concentration in the region of about 10⁻³ molar being especially suitable. Although there is no particular upper limit to the chloride ion concentration, up to about 5×10⁻² molar is typically suitable. The chloride ion concentration may be expressed as pCl values where pCl is −log₁₀[Cl⁻]:10⁻⁴ molar is pCl 4 and 10⁻³ molar is pCl 3. In the method of the invention, control of the chloride ion concentration during precipitation determines the shape, size, and size distribution of the silver chloride particles.

According to one embodiment of the invention, control of the chloride ion concentration during the precipitation may be achieved by an appropriate choice of the solution concentrations and jetting rates. The actual concentrations are not particularly important, but to maintain the chloride excess the concentration of the chloride solution may be slightly greater than that of the silver solution. Alternatively, the jetting rate of the chloride solution may be slightly greater.

According to another embodiment of the invention, precipitation may be controlled by feedback from the silver ion or chloride ion concentration in the precipitation vessel using a suitable ion selective electrode. Typically, the chloride ion concentration in the precipitation vessel is monitored during the course of the reaction with a suitable ion selective electrode, for example a clean silver electrode, and the desired pCl value maintained by feedback from the electrode to control the addition rate of the chloride solution, with the silver salt solution jetted at a constant rate. Alternatively, the chloride solution may be jetted at a constant rate and addition of the silver salt solution controlled by feedback from the electrode. The solution concentrations may be selected to provide the desired final silver loading of the composition with a convenient jetting rate and reaction time.

Optionally, a small charge of a suitable soluble chloride salt may be added to the precipitation vessel in order to achieve the desired chloride ion excess before starting the precipitation reaction, either as a separate addition to the initial liquid charge or by jetting some of the chloride solution before starting to jet the silver. Further, additional chloride ions may be added after completion of precipitation to maintain an excess of chloride ions and minimise solubility of the silver halide. Deionised water may be used for the precipitation reaction.

Further, the temperature may be controlled during the precipitation. The reaction may be carried out at ambient temperature or the temperature may be controlled; temperatures in the range from about 0° C. to about 70° C. are suitable with about 20° C. to about 40° C. being typical. There may also be present during the precipitation reaction further auxiliary agents as are known in the art, such as antifoaming agents, stabilisers, and the like.

The pH of the reaction is not particularly limited but may be selected as appropriate, for example it may be in the range between about 4 and about 7.

According to another embodiment of this aspect of the invention, there is provided a method for preparation of a biocidal composition comprising a copper compound by controlled precipitation of a copper compound in the presence of a polymer. The polymer is typically thermoplastic and typically in the form of a dispersion.

Typically, the controlled precipitation is carried out by the double jetting method; that is to say that separate aqueous solutions of a soluble copper salt and a salt of the appropriate counterion are simultaneously pumped into a precipitation vessel in the presence of a typically thermoplastic polymer, and the reaction mixture is stirred during the precipitation reaction. Good mixing is necessary for optimum control of the reaction. The jetting nozzles for the copper and counterion solutions may be arranged below the liquid surface in the precipitation vessel to allow the reagents to be added directly into the mixture rather than onto the surface.

By an appropriate counterion is meant the anion necessary to provide the desired copper compound. In the case of copper, the anion is typically an alkali compound. Typically, the precipitated copper compound is basic copper(II) chloride and the precipitation reaction involves double jetting solutions of copper chloride and alkali. Suitable alkalis include but are not limited to lithium, sodium, and potassium hydroxide, of which sodium hydroxide is most typical.

For the basic copper chloride of the invention, for example, control of the precipitation may typically be achieved by control of alkali concentration, that is to say by control of pH. A suitable pH is between about 5 and about 7, with a pH of between about 5.5 and about 6 being especially typical. In the method of the invention, control of the pH during precipitation determines the shape, size, and size distribution of the basic copper chloride particles. Deionised water may be used for the precipitation reaction.

According to one embodiment of the invention, control of pH during the precipitation may be achieved by appropriate choice of the solution concentrations and jetting rates. According to another embodiment of the invention, precipitation may be controlled by feedback from pH in the precipitation vessel using a suitable ion selective electrode during the course of the reaction, and the desired pH value maintained by feedback from the electrode to control addition rate of the hydroxide solution, with the copper salt solution jetted at a constant rate. Alternatively, the hydroxide solution may be jetted at a constant rate and addition of the copper salt solution controlled by feedback from the electrode.

For the preparation of dicopper chloride trihydroxide, for example, the copper chloride solution and hydroxide ions may be provided to the reaction in a molar ratio of, for example, about 2:3. The actual concentrations are not particularly important, and may be selected to provide the desired final loading of the composition with convenient jetting rate and reaction time.

It is normal to start with an initial liquid charge in the precipitation vessel to permit the reaction to be stirred at the commencement of jetting. It may also be advantageous for the jetting nozzles for addition of the reagents to be below the surface of the initial charge.

The polymer may be a thermoplastic polymer and may be in the form of a dispersion or suspension in water as hereinbefore described. In one embodiment of the invention, the dispersion may be present as the initial liquid charge to the precipitation vessel before jetting the copper chloride and alkali solutions.

Alternatively, the dispersion may be pre-mixed with either the copper salt solution or the hydroxide solution or with both solutions and jetted with these solutions, or it may be added as a separate addition during the precipitation reaction or by a combination of such methods.

Typically, the thermoplastic polymer dispersion comprises a surfactant. The surfactant used is not particularly limited as long as it is compatible with the other components. Examples of suitable surfactants include, but are not limited to, nonionic surface active agents such as alkylene oxide derivatives, for example alkoxylated alcohol ethers, acetylenic alcohol polyethylene glycol ethers, polyethylene glycol alkylaryl ethers, polyethylene glycol esters, or polyethylene glycol/polypropylene glycol condensates; glycidol derivatives; aliphatic esters of polyhydric alcohols or sucrose; anionic surfactants such as alkyl naphthalene sulphonates, alkylbenzenesulphonates, alkyl sulphonates, dialkyl sulphosuccinates, N-acyl-N-alkyl taurines, N-acyl sarcosines, or surfactants comprising a sulphuric acid ester group, such as alkyl sulphuric acid esters and sulphated polyethylene glycol alkyl or alkylaryl ethers; and salts of the above anionic surfactants. Such surfactants are well known in the art. Alkoxylated alcohol and sulphated alkoxylated alcohol surfactants are especially suitable. The proportion of surfactant may be up to about 10% of the polymer by dry weight, typically in the range of about 1% to about 2.5%.

The precpitation reaction may be carried out at ambient temperature or the temperature may be controlled; temperatures in the range from about 0° C. to about 70° C. are suitable with about 20° C. to about 40° C. being typical. There may also be present during the precipitation reaction further auxiliary agents as are known in the art, such as antifoaming agents, stabilisers, and the like.

According to a third embodiment of this aspect of the invention, there is provided a method for the preparation of a biocidal composition comprising a zinc compound by controlled precipitation of a zinc compound in the presence of a polymer. The polymer is typically thermoplastic and typically in the form of a dispersion.

Typically, the controlled precipitation is carried out by the double jetting method; that is to say that separate aqueous solutions of a zinc salt and of a salt of the appropriate counterion are simultaneously pumped into a precipitation vessel in the presence of a (thermoplastic) polymer, and the reaction mixture is stirred during the precipitation reaction. Good mixing is necessary for control of the reaction. The jetting nozzles for the zinc and counterion solutions may be arranged below the liquid surface in the precipitation vessel to allow the reagents to be added directly into the mixture rather than onto the surface.

By an appropriate counterion is meant an anion necessary to provide the desired zinc compound. In the case of zinc, as with copper, the anion is typically an alkali compound. Typically, the precipitated zinc compound is zinc oxide and the precipitation reaction involves double jetting solutions of a suitable water soluble zinc salt and alkali. Suitable zinc salts include but are not limited to zinc chloride, zinc nitrate, zinc sulphate, and zinc acetate. Suitable alkalis include but are not limited to lithium, sodium, and potassium hydroxide. Typically, sodium hydroxide is used.

For the zinc oxide of the invention, for example, control of the precipitation may typically be achieved by control of the alkali concentration, that is to say by control of pH. A suitable pH is between about 9 and about 11, with a pH between about 9.5 and about 10 being most typical. In the method of the invention, control of the pH during precipitation determines the shape, size, and size distribution of the zinc, oxide particles.

According to one embodiment of the invention, control of pH during the precipitation may be achieved by an appropriate choice of the solution concentrations and jetting rates. According to another embodiment of the invention, precipitation may be controlled by feedback from pH in the precipitation vessel using a suitable ion selective electrode during the course of the reaction, and the desired pH value maintained by feedback from the electrode to control addition rate of the hydroxide solution, with the zinc salt solution jetted at a constant rate. Alternatively, the hydroxide solution may be jetted at a constant rate and addition of the zinc salt solution controlled by feedback from the electrode.

For the preparation of e.g. zinc oxide, the zinc salt and hydroxide ion may be provided to the reaction in a molar ratio of, for example, about 1:2. The actual concentrations are not particularly important, and may be selected to provide the desired final loading of the composition with convenient jetting rate and reaction time, provided to the reaction in a molar ratio of, for example, about 1:2. The actual

It is normal to start with an initial liquid charge in the precipitation vessel to permit the reaction to be stirred at the commencement of jetting. It may also be advantageous for the jetting nozzles for addition of the reagents to be below the surface of the initial charge.

The polymer may be a thermoplastic polymer and may be in the form of a dispersion or suspension in water as hereinbefore described. In one embodiment of the invention, the dispersion may be present as the initial liquid charge to the precipitation vessel before jetting the zinc salt and alkali solutions.

Alternatively, the dispersion may be pre-mixed with either the zinc salt solution or the hydroxide solution and jetted with these solutions, or it may be added as a separate addition during the precipitation reaction or by a combination of such methods.

Typically the thermoplastic polymer dispersion comprises a surfactant. The surfactant used is not particularly limited as long as it is compatible with the other components. Examples of suitable surfactants include, but are not limited to: nonionic surface active agents such as alkylene oxide derivatives, for example alkoxylated alcohol ethers, acetylenic alcohol polyethylene glycol ethers, polyethylene glycol alkylaryl ethers, polyethylene glycol esters, or polyethylene glycol/polypropylene glycol condensates; glycidol derivatives; aliphatic esters of polyhydric alcohols or sucrose; anionic surfactants such as alkyl naphthalene sulphonates, alkylbenzenesulphonates, alkyl sulphonates, dialkyl sulphosuccinates, N-acyl-N-alkyl taurines, N-acyl sarcosines, or surfactants comprising a sulphuric acid ester group, such as alkyl sulphuric acid esters and sulphated polyethylene glycol alkyl or alkylaryl ethers; and salts of the above anionic surfactants. Such surfactants are well known in the art. Alkoxylated alcohol and sulphated alkoxylated alcohol surfactants are especially suitable. The proportion of surfactant may be up to about 10% of the polymer by dry weight, typically in the range of about 1% to about 2.5%.

The reaction may be carried out at ambient temperature or the temperature may be controlled; temperatures in the range from about 60° C. to about 100° C. are suitable with a temperature of approximately about 80° C. being typical. Further, there may also be present during the precipitation reaction further auxiliary agents as are known in the art, such as metal complexing agents, antifoaming agents, stabilisers, and the like.

After precipitation, the biocidal composition may be used as a stabilised dispersion. Alternatively, the solid components may be separated or concentrated by any suitable means such as filtration, centrifugation, sedimentation, decantation, or by cross-flow filtration such as ultrafiltration or microfiltration. If desired, the composition may be washed with water to remove excess salt by product and excess surfactant, and may then be dried.

The compositions of the invention are useful for many applications wherein biocidal properties are important. Such uses include but are not limited to disinfection and preservation of surfaces, films, and coatings; materials such as paints, plastics, packaging, sealants, wall adhesives, binders, fabrics, clothing, papers, detergents, personal care products, and products for animal or human hygiene; and articles such as equipment, furniture, walls, floors, machinery, containers, membranes, filters, pipework, medical devices, wound dressings, and the like.

In one embodiment, the composition of the invention may be used as a coating to provide biocidal activity to the surface of an article. Any article can be coated with the biocidal composition of the present invention. The composition of the invention may be used as an additive to an existing coating composition, for example a paint or a powder coating composition, or may be used as part of a biocidal coating formulation additionally comprising components such as but not limited to binders and carriers. Further, the coated article may be heated after coating to form a film from the thermoplastic polymer particles.

In another embodiment, the biocidal composition of the invention may be melt processed, for example, by injection moulding or extrusion to provide an article with biocidal properties. The composition of the invention may be used as an additive in combination with other polymers to provide the article. Polymers which are useful to form the articles of the invention include, but are not limited to, natural and synthetic rubber, especially latex rubber, acrylonitrile rubber, PVC, polyurethanes, silicone, polycarbonates, acrylates, polypropylenes, polyethylenes, polytetrafluoroethylenes, polyvinylacetate, poly(ethylene terephthalate), polyesters, polyamides, polyureas, styrene-block copolymers, polymethyl methacrylate, acrylic-butadiene-styrene copolymers, polystyrene, cellulose, and derivatives and copolymers of any of the above.

To illustrate the invention further, reference will made to the following Figures:

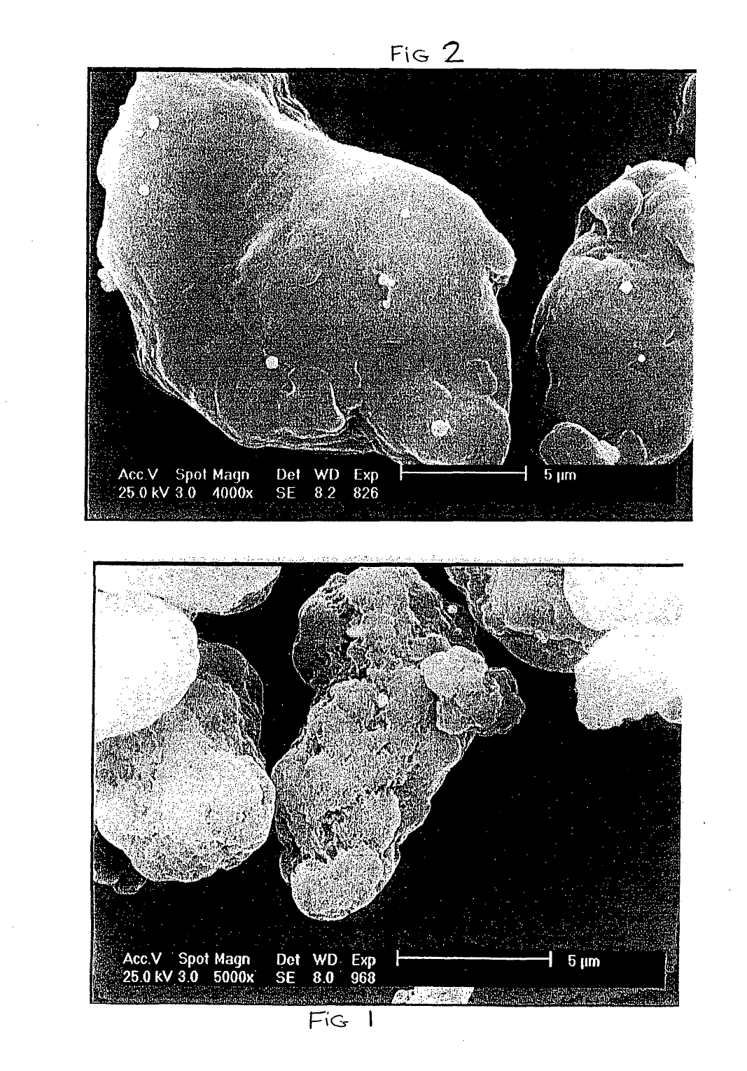

FIG. 1 shows a scanning electron micrograph of the silver chloride/polyamide composition produced in the following Example 2. The large irregular polyamide particles are visible with the silver chloride appearing as small bright particles attached to the somewhat rough surface of the polyamide. The silver chloride particles are roughly cubic in shape, and it will be seen that they are present as discrete particles rather than as aggregates or agglomerates and also that they are attached to the polyamide particles with no free silver halide. It is not possible to obtain very accurate sizing data for the silver chloride in the presence of the larger polyamide particles, but inspection of the image suggests that the edge length of the cubes is approximately 200 nm with no oversize particles.

FIG. 2 shows a scanning electron micrograph of the silver chloride/polyethylene composition produced in the following Example 6. The large irregular polyethylene particles are visible with the silver chloride appearing as small bright particles attached to the surface of the polymer. The silver chloride particles are roughly cubic in shape, and it will be seen that they are present as discrete particles rather than as aggregates or agglomerates and also that they are attached to the polyethylene particles with no free silver halide. It is not possible to obtain very accurate sizing data for the silver chloride in the presence of the larger polyethylene particles, but inspection of the image suggests that the edge length of the cubes is in the range of 100 to 400 nm with no oversize particles.

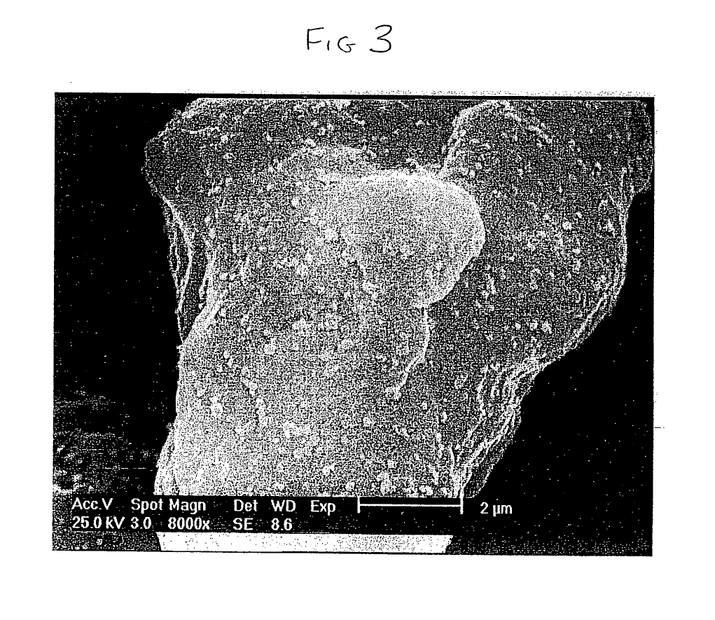

FIG. 3 shows a scanning electron micrograph of the basic copper chloride/polyethylene composition produced in the following Example 7. The basic copper chloride appears as small bright particles attached to the surface of the large irregular polyethylene particle. It will be seen that the basic copper chloride particles are present as discrete particles rather than as aggregates or agglomerates and also that they are attached to the polyethylene particles with no free copper halide. It is not possible to obtain very accurate sizing data for the basic copper chloride in the presence of the larger polyethylene particles, but inspection of the image suggests that the size range is between approximately 1.00 nm and about 300 nm with no oversize particles.

One of the advantages of the invention is that the small inorganic compound particles attach and adhere to the carrier thermoplastic polymer particles, as shown in the electron micrographs. Further, the controlled precipitation method of the invention gives a narrow size distribution of the inorganic compound particles, with no oversize particles and with little tendency towards aggregation. These characteristics of the inorganic compound particles greatly aid handling and processing of the composition. For example, it can readily be separated by filtration to remove the salt byproduct of the preparation and excess surfactant without risk of the metal salt particles settling out. Silver halide particles prepared according to the invention are sufficiently small that they are relatively insensitive to light and resistant to printout. An additional advantage of the method of the invention is that it provides inorganic compound particles of controlled small particle size and narrow size distribution in the absence of gelatin or other water-soluble stabilising colloid. Such water-soluble polymers are too attractive to bacteria and liable to promote growth and would also be incompatible with melting of the thermoplastic polymer. Still further, the method of the invention provides small particles of the inorganic compound without requiring grinding or other mechanical processing.

The invention will now be described further by way of example with reference to the following examples which are intended to be illustrative only and in no way limiting upon the scope of the invention. Manipulations of silver salts in the following examples were carried out in subdued light, but it is not necessary to use darkroom or safelight conditions. Unless otherwise shown, all quantities in the examples are given by weight.

### EXAMPLE 1

A polyamide dispersion was prepared by slowly adding 505 grams of a polyamide powder to a stirred solution of 2.5 grams of a polyethylene glycol alkyl ether surfactant in 2.5 litres of deionised water. The polyamide used was a commercial sample of a nylon 6/12 copolymer powder having an average particle size of 10 μm and a specific surface area of 20 m²/g. The surfactant was a commercial alkoxylated alcohol having the approximate formula C₁₆H₃₃(OCH₂CH₂)₂₀OH. A stable dispersion was formed that only settled out slowly on standing. 5 ml of 1 molar silver nitrate solution was added to the above polyamide dispersion; in order to maintain suspension during the jetting process, the mixture was stirred during addition to the precipitation reaction.

Silver chloride was precipitated by double-jetting the silver-containing dispersion and a 0.01 molar solution of sodium chloride into a cylindrical precipitation vessel equipped with a paddle stirrer and a clean silver electrode set up to measure chloride ion concentration. The precipitation vessel was held in a thermostatted bath at 40° C. during the reaction, and sufficient deionised water (approximately 500 ml) to cover the stirrer paddle and jetting nozzles charged to the vessel. Jetting of the chloride solution was started first, and when chloride ion concentration had risen to pCl 4, jetting of the silver-containing dispersion was started. The chloride was added at a rate of 4.2 ml/minute during 2 hours and the silver solution added at such a rate that pCl was maintained at 4. The resulting silver chloride/polyamide composition was filtered off, washed with water, and dried. The yield was 516 g and the residual water content was less than 1%.

### EXAMPLE 2

A polyamide dispersion was prepared as in Example 1 by dispersing 503 g of the same polyamide powder in 2500 ml deionised water containing 45 ml of a 27% solution of a commercial alkoxylated alcohol ether sulphate sodium salt surfactant based on C₁₂-C₁₃ alcohols and having approximately 3 moles of ethylene oxide. A stable dispersion was formed that only settled out slowly on standing. 10.64 ml of 4.7 molar silver nitrate solution was added to the polyamide dispersion, and the mixture stirred during the precipitation reaction.

Silver chloride was precipitated by double-jetting the silver-containing dispersion and a 0.1 molar solution of sodium chloride into a vessel equipped with a paddle stirrer and a clean silver electrode set up to measure chloride ion concentration. The precipitation vessel was held in a thermostatted bath at 40° C. during the reaction, and sufficient deionised water (approximately 500 ml) to cover the stirrer paddle and jetting nozzles charged to the vessel. Jetting of the chloride solution was started first, and when chloride ion concentration had risen to pCl 3, jetting of the silver-containing dispersion was started. The chloride was added at a rate of 4.2 ml/minute during 2 hours and the silver solution added at such a rate that pCl was maintained at 3. The silver chloride/polyamide composition was filtered off, washed with water, and dried. The silver content was measured as 1.1% as silver.

A scanning electron micrograph of the composition is shown in the accompanying FIG. 1. The presence of crystalline silver chloride was shown by X-ray diffraction.

### EXAMPLE 3

A silver chloride/polyamide composition according to the invention was prepared. 1.509 kg of the polyamide powder as in Example 1 was dispersed in 7.5 kg of deionised water with 139 g of the same commercial surfactant as in Example 2. The dispersion was stirred with a dispersing disc stirrer, 25 ml of an organic antifoaming agent added and then an initial charge of 180 ml of 0.051 molar aqueous sodium chloride solution. Silver chloride was precipitated by double jetting 3.01 kg of 0.05 molar silver nitrate and 3.01 kg of 0.051 molar sodium chloride solutions at a rate of 150 ml/minute below the surface of the stirred polyamide dispersion. Addition of the silver was then stopped and a further 0.35 kg of chloride solution added at the same rate. The silver chloride/polyamide composition was filtered off, washed with water, and dried. The yield was 1.48 kg, the residual water was below 1% and the silver content was measured as 0.94% as silver. Scanning electron microscopy showed the presence of small cubes of edge length 0.1-0.2 μm.

### EXAMPLE 4

A polyamide dispersion was prepared by adding 3.3 kg of the polyamide powder as in Example 1 with stirring to a solution comprising 295 ml of the 27% surfactant solution as in Example 2 and 50 ml antifoam in 9.6 kg deionised water. After addition, a further 3.6 kg of water was added and then an initial charge of 84 ml of 0.202 molar sodium chloride solution. The dispersion was stirred with a dispersing disc stirrer and silver chloride precipitated into it by double jetting solutions of 0.200 molar silver nitrate and 0.202 molar sodium chloride below the surface of the polyamide dispersion. The solutions were jetted at a rate of 150 nil/minute until 7.3 kg of each had been added. Addition of the silver was then stopped and a further 1.2 kg of chloride solution added at the same rate. The silver chloride/polyamide composition was filtered off, washed with water, and dried. The yield was 3.26 kg, the residual water was below 1% and the silver content was measured as 3.4% as silver.

### EXAMPLE 5

A silver chloride/polyamide composition according to the invention was prepared as in Example 3. 2.535 kg of the polyamide powder as in example 1 was dispersed in 10.08 kg of deionised water with 181 g of a commercial alkoxylated alcohol surfactant available from Tego® Chemie under the trade name of TEGO® Wet 500. An initial charge of 125 ml of 0.101 molar aqueous sodium chloride solution was added to the dispersion in the precipitation vessel, and then silver chloride was precipitated by double jetting 0.100 molar silver nitrate and 0.101 molar sodium chloride solutions at a rate of 42 ml/minute for 60 minutes below the surface of the dispersion. The product was filtered off, washed with a further 10 kg water, and dried. The yield was 2.46 kg, the residual water was below 1% and the silver content was measured as 1.01% as silver.

The silver content of the total filtrate was measured as 0.08 ppm. This is below the saturation concentration to be expected from silver chloride because of the chloride excess, but shows that essentially all the silver chloride is retained in the product with none passing through the filter despite the small particle size.

### EXAMPLE 6

A silver chloride/polyethylene composition according to the invention was prepared. 320 g of a commercial low-density polyethylene powder having an average particle size of 10-15 μm was dispersed in 1280 g of deionised water with 6 ml of the same commercial alkoxylated alcohol surfactant as in Example 5. An initial charge of 23 ml of 0.051 molar aqueous sodium chloride solution was added to 1168 g of this dispersion, and then silver chloride was precipitated by double jetting 0.050 molar silver nitrate and 0.051 molar sodium chloride solutions at a rate of 46 ml/minute for each solution for 10 minutes. The product was filtered off, washed with water, and dried. The residual water was below 0.1%.

The silver content of the initial filtrate was measured as 0.03 ppm and of the washings 0.21 ppm, thus showing that essentially all the silver chloride is retained in the product. A scanning electron micrograph of the composition is shown in the accompanying FIG. 2.

### EXAMPLE 7

A basic copper chloride/polyethylene composition according to the invention was prepared. A dispersion of the same commercial low-density polyethylene powder as in example 6 was prepared as in Example 6.50 g of this dispersion was taken, and basic copper chloride precipitated by double jetting 0.5 molar copper chloride at a rate of 1 ml/minute for 4 minutes and controlling the addition of a 0.1 molar sodium hydroxide solution to maintain pH at 5.8. The total addition of hydroxide solution was 24.5 ml. The product was filtered off, washed with water, and dried to give a pale green solid. A scanning electron micrograph of the composition is shown in the accompanying FIG. 3. The precipitated salt was shown to comprise basic copper chloride as a mixture of polymorphs of dicopper chloride trihydroxide by X-ray diffraction.

It is of course to be understood that the present invention is not intended to be restricted to the foregoing examples which are described by way of example only.

1. A biocidal composition comprising:
i) an inorganic compound; and
ii) a polymer;
wherein the inorganic compound is prepared by a controlled precipitation technique.

2. A composition according to claim 1, wherein the inorganic compound and the polymer are in particulate form.

3. A composition according to claim 1, wherein the inorganic compound comprises a silver, copper or zinc compound.

4. A composition according to claim 3, wherein the inorganic compound is selected from silver chloride, silver bromide, silver iodide, silver sulphate, silver carbonate, silver oxide, or an admixture of any two or more thereof; or is a copper(I) or copper(II) compound, or is a zinc compound selected from zinc oxide, zinc sulphide, basic zinc sulphate, basic zinc chloride, basic zinc oxide, zinc borate, zinc hydroxide, zinc benzoate, any hydrate thereof, or mixtures of any two or more thereof.

5. A composition according to claim 4, wherein the copper(II) compound is selected from basic copper chloride, basic copper sulphate, basic copper carbonate, copper oxide, or copper hydroxide, or wherein the copper(I) compound is cuprous oxide or copper thiocyanate.

6. A composition according to claim 5, wherein the basic copper chloride is selected from copper chloride hydroxide, dicopper chloride trihydroxide, compositions of the formulae CuCl(OH), Cu₂Cl(OH)₃, Cu₂(OH)₃Cl, CuCl_{0.5}(OH)_{1.5}, Cu₄Cl₂(OH)₆.3H₂O, Cu₃Cl₄(OH)₂.H₂O, Cu₅Cl₃(OH)₇, any hydrate thereof, mixtures of any two or more thereof, and nonstoichiometric compositions.

7. A composition according to claim 2, wherein the average particle size of the inorganic compound is less than about 1 μm.

8. A composition according to claim 1, wherein the composition comprises the inorganic compound in an amount of up to about 20% by dry weight of the polymer.

9. A composition according to claim 1, wherein the polymer is thermoplastic.

10. A composition according to claim 9, wherein the average particle size of the thermoplastic polymer is no more than about 100 μm.

11. A composition according to claim 1, wherein the thermoplastic polymer is selected from polyamide, polyolefin, polyethylene, polypropylene, polymethyl methacrylate (PMMA), polytetrafluoroethylene (PTFE), polyurethane, polystyrene, polyvinyl chloride (PVC), polyvinylidine chloride (PVDC), polyvinylacetate, polyester, poly(ethylene terephthalate) (PET), poly(butylene terephthalate), polyvinyl acetal, polyvinyl butyral, polycarbonate, a styrene-butadiene copolymer, ethylene-vinyl acetate (EVA) copolymer, ethylene-acrylic acid (EAA) copolymer, acrylonitrile-butadiene-styrene (ABS) copolymer, or an admixture of any two or more thereof.

12. A composition according to claim 11, wherein the thermoplastic polymer is selected from polyamide 6, polyamide 11, polyamide 12, polyamide 4/6, polyamide 6/6, polyamide 6/10, polyamide 6/12, polyurethane, polyethylene, or polypropylene.

13. A composition according to claim 1, wherein the composition further comprises one or more surfactant or dispersant compositions.

14. An article comprising a composition according to claim 1.

15. A method of preparing a composition according to claim 1, comprising a controlled precipitation of an inorganic compound in the presence of a polymer.

16. A method according to claim 15, comprising:
i) providing a source of a cation and a source of an anion; and
ii) mixing the cation source and the source of an anion with a polymer to prepare an inorganic compound;
wherein the inorganic compound is prepared using a controlled precipitation technique.

17. A method according to claim 15 wherein the controlled precipitation is carried out using a double jetting method.

18. A method according to claim 17 wherein the method is carried out using an excess of the anion source compared with the cation source.

19. A method according to claim 17, wherein the anion source is an alkali.

20. A method according to claim 19, wherein the alkali is selected from lithium hydroxide, sodium hydroxide and potassium hydroxide.

21. A method according to claim 15, wherein the inorganic compound comprises a silver, copper or zinc compound.

22. A method according to claim 15, wherein the polymer is thermoplastic.

23. A method according to claim 22, wherein when the inorganic compound is a silver compound the pH is maintained between about 4 and about 7; wherein when the inorganic compound is a copper compound the pH is maintained between about 5 and about 7; and when the inorganic compound is a zinc compound the pH is maintained between about 9 and about 11.

24. Use of a composition according to claim 1 as an antimicrobial agent.
